(19) United States
(12) Patent Application Publication
(10) Pub. No.: US 2007/0179888 A1
(43) Pub. Date: Aug. 2, 2007

(54) System for organizational fundraising using retail gift cards

(76) Inventor: Arielle Angelovich, Texarkana, TX (US)

Correspondence Address: Steven Thrasher, 391 Sandhill Dr., Richardson, TX, 75080, US

(21) Appl. No.: 11/598,521

(22) Filed: Nov. 13, 2006

Related U.S. Application Data
(60) Provisional application No. 60/735,292, filed on Nov. 10, 2005.

(51) Int. Cl. G06Q 40/00

(52) U.S. Cl. 705/41

(57) ABSTRACT

The invention provides a method of increasing charitable giving. The method generally provides an indicia of a gift, the indicia having a denomination associated therewith, associating a charity with the indicia, and debiting the indicia and transferring an amount of the denomination to the charity. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### TECHNICAL FIELD OF THE INVENTION

The invention relates to financial transaction processing.

### PROBLEM STATEMENT

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

Discussion

Charities are constantly looking for new ways to raise awareness and revenue. During recessions, money is scarce. During an expanding economy, persons are distracted by voluminous advertising. Without funding, the poor, disadvantaged, and disaster victims do not get the help they need. Accordingly, The present invention provides new methods for charity fundraising.

### BRIEF DESCRIPTION OF THE DRAWINGS

Various aspects of the invention, as well as an embodiment, are better understood by reference to the following detailed description. To better understand the invention, the detailed description should be read in conjunction with the drawings, in which like numerals represent like elements unless otherwise stated.

FIG. 1 is a block-flow diagram of a method according to the invention.

### EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for -functioning-” or “step for -functioning-” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise. Furthermore, it is understood that it is not necessary to perform the acts identified in the order identified unless stated as being sequential.

Of course, the foregoing discussions and definitions are provided for clarification purposes and are not limiting. Words and phrases are to be given their ordinary plain meaning unless indicated otherwise.

Description of the Drawings and Selected Alternative Embodiments

Retail gift cards have experienced explosive growth. Several billion dollars of gift cards were sold in 2004, and continued growth is expected. Practically every major brick and mortar and online retailer offers gift cards. Gift cards provide benefits to retailers because they can generate revenue before delivering any product or service. Gift cards also provide benefits to consumers because they solve the problem of deciding what to give and are easily carried. A gift can be given that avoids a social stigma of giving cash, but the recipient decides what they want in the end—provided that there remains a balance on the card.

Gift cards have created a certain amount of controversy, however. The terms of service or contract terms for almost all gift cards frequently provide for (a) a monthly service charge that depletes the balance as each month passes; and (b) a expiration date whereby the entire unused balance is forfeited if the card if not used by a certain time.

It seems to be that it is just human nature that consumers forget about gift cards and forget to use gift cards before the expiration date. Many cards are ultimately lost or misplaced. Because of this, a significant percentage of the gift card face value reverts to the issuer. These “features” of gift cards result in a windfall to corporations of hundreds of millions per year. In fact, this is a significant reason why corporations heavily promote gift cards.

This problem has created growing concern with courts and state legislators. There have been several class action lawsuits over gift card forfeiture. Further, close to a dozen states have passed laws eliminating monthly fees or balance forfeiture.

This invention provides a system and method for addressing the problem of gift card balance forfeiture to the benefit and advantage of charitable entities. Many gift cards are given during Christmas and for other occasions that reflect the spirit of generosity. Solving the gift card monthly fee and balance forfeiture problems while benefiting charities is in keeping with the spirit of giving.

The systems and methods described in this disclosure may be implemented at retail locations or through online purchases of gift certificates. In retail locations, gift certificates are usually purchased by requesting a gift certificate or gift card in a selected or predetermined denomination. Sometimes the un-activated cards are displayed by the checkout stand. Sometimes the purchaser fills out a card for the gift certificate. Usually, the cards are scanned and the unique identifying number is recorded and the card associated with that number is activated after payment is confirmed.

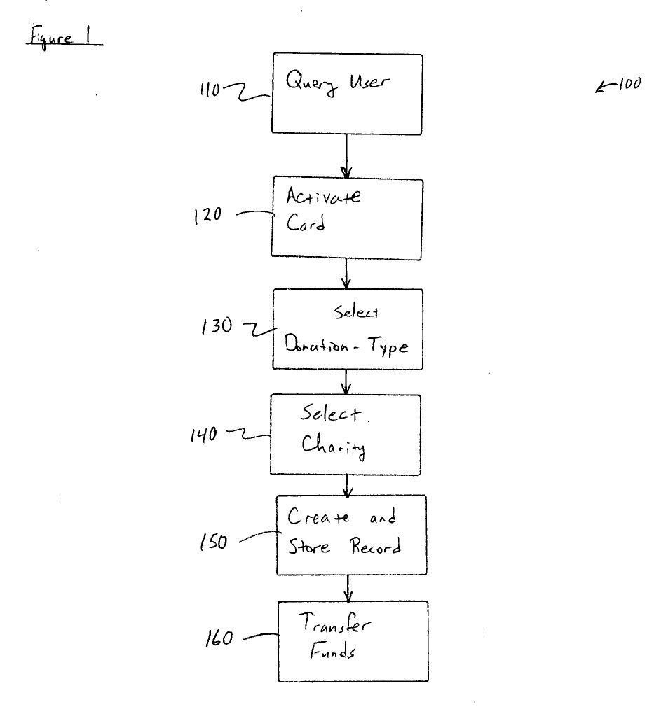

FIG. 1 is a block-flow diagram of a method 100 according to the invention. The method 100, performable and storable on a computer platform, begins with a query user act 100 in which a user, who is purchasing a gift card at a merchant point of purchase, is presented with the option of participating in an organizational fundraising program by designating some portion of a gift card purchase with an organization. When the user elects to participate and the system receives an indication from the user that the user wishes to designate some portion of a gift card purchase for an organization, the method 100 next proceeds to activate the charity feature of the gift card in an activate card act 200. Next, in a select donation-type act 130, the user is presented with a choice of donation options, and the system receives a donation-type decision from the user. For example, the user may choose to make an immediate, single donation, a monthly donation, or a balance donation at some date in the future.

Then, in a select charity act 140, the system presents to the user a choice of selectable charities, and receives from the user an organization selection decision. The data identifying the gift card, the donation-type, and the selected charity are thus stored as a record in a create and store record act 150. Accordingly, at some point in time concurrently or thereafter, based on the donation-type selected, a first portion of the funds are deducted from the gift-card and transferred to the organization. Thus, funds are transferred to the organization in a transfer funds act 160. The following description of alternative methods and variations thereof provide additional insight to the invention.

In one embodiment, the practice of the invention adds the following acts at the retail location:
1. Either through a verbal or written query, the purchaser is asked if they wish to consider charity options associated with the gift card.
2. If the consumer consents, these presented options could include, but not be limited to the following:
   a. That an immediate portion or percentage of the purchase price would go to a charity.
   b. That a certain amount of money would be deducted from the card each month and that the amount would be transmitted to a charity.
   c. That any unused balance on the card after the expiration of a certain number of months would be transmitted to the charity.
3. If the customer is interested in one or more of these options, the customer selects from these or other options verbally or through a written form.
4. The customer would then select an applicable charity or charities to receive the benefits described above. The amounts could be divided between charities or all go to a single charity.
5. Based on the customer responses, the cashiers the particular charity features of the card, including the options selected and the charities. This can be accomplished through manual input or by scanning a form completed by the customer or by scanning bar codes or similar patterns corresponding to the options selected.

Alternatively, if the time spent entering the data or obtaining decisions from the customer is too much for certain high volume, retail locations, one of two options can be pursued:
1. The retailer simply asks if the purchaser would like to activate a charity feature and this charity feature is activated in response with the particular options and charity selected by the retailer. It is an additional option to provide the purchaser with a record of what charity would be the recipient of any funds.
2. The retailer asks if the purchaser would like to activate the charity option and then provides the purchaser with a card (that would accompany the gift card). This might be a peel off label on the card. This card or peel off label has a web site address where the purchaser can go after the purchase and set the charity options, within ranges determined by the retailer. The purchaser enters an identifying gift card number (printed on the card) and possibly a second number printed on the pull-off label. Once the options have been set, the peel off label can be removed and then the recipient of the gift card is unable to set or modify the options.
a. The retailer could set a time limit for the purchaser to select. If the purchaser does not select in the time designated, the charity function either becomes null and void or it reverts to a charity and option set by the customer.
b. The retailer could allow changes to be made a single time or could allow multiple changes.

Alternatively, all the steps discussed above could be completed online, or remotely via a telephone, or a mobile device such as cell phone or text messaging. The options discussed above would be presented online during the gift certificate purchase process.

As a result of the following steps, either occurring at the retail location, online, or a combination of both, a record is created that contains the following linked information. The record does not need to be stored on the same storage media on the same computer:
1. Identifying number for the gift certificate
2. Data corresponding to the charity options selected by the customer, which might include the following:
   a. Identifying codes for each applicable charity
   b. Allocation percentages between charities
   c. Monthly payment amount to charity
   d. Whether the unpaid balance is to be paid to the charity
   e. Any other options selected by the customer
3. The records may also include associated data
   a. Face amount of certificate
   b. Balance of certificate
   c. Expiration date
   d. Charity reversion date
   e. Identifying information for purchaser (email, name or address)

A computer system then stores and tracks this data over time to distribute the money to the charities when the conditions set by the purchaser occur.
1. If money is to be paid monthly from the certificate, the system deducts the amount from the unpaid balance and sends it to the charity via check or EFT or wire.
   a. The system may aggregate the sums with other funds to be transmitted to a certain charity.
   b. The system may transmit the funds to a different account and hold until a time set by the retailer.
3. If money is to be paid at the expiration of the gift card, the system tracks the expiration date and effectuates the transfer when the condition occurs.
4. The system would track and accomplish the transfer of funds under any other conditions mutually agreeable to the purchaser or agreed to be the retailer.

Other aspects of this invention may include:
1. When a transfer to a charity is made, the system periodically or annually sends a mailed or emailed receipt to the purchaser for tax deduction purposes since the amounts are sent to tax exempt charities.
2. The system accounts for all transfers to charities if the terms of service provide that the tax deduction shall accrue to the retailer.
3. The system tracks all charitable contributions made under the program and then feed that data to the retailers web sites or the charities web sites for marketing and promotional purposes.
4. It provides an interface for recognized charities to enroll in the program
5. It provides promotion of the charities at the retailers web site and promotion of the retailer at the charity web site.
6. It provides a way for the original purchaser, using a tracking number, which may be the gift certificate ID number, to determine how much money was ultimately distributed to a charity.

Alternatively, this invention could be used for non-charitable fundraising.

Alternatively, this invention could be used for local fundraising, particularly school fundraising as described above, or with the following enhancements.
1. Retailers already sell gift cards at below face value to schools and other organizations for fundraising. For example, the retailer might take $9.00 for a $10.00 face value card and then the organization (such as a school) keeps the $1.00. Because the gift cards are being sold for school fundraising purposes, purchasers might be more likely to purchase because of special interest in the organization.
2. However, all the problems discussed above still apply—monthly fees and forfeiture.
3. Application of the invention to the school fundraising program could further enhance the final amount received by the school.
   a. Because these cards might be purchased by persons who do not intend to use them, it is more likely the card would expire.
   b. Therefore, adding the invention to existing gift card fundraising programs would enhance the fundraising end result.

Alternatively, this invention could be implemented by a third-party vendor who runs and manages the gift card programs of many different gift card retailers.

Though the invention has been described with respect to a specific preferred embodiment, many variations and modifications (including equivalents) will become apparent to those skilled in the art upon reading the present application. It is therefore the intention that the appended claims and their equivalents be interpreted as broadly as possible in view of the prior art to include all such variations and modifications.

I claim:

1. A method of providing organizational fundraising, comprising:
querying a user at a retailer point-of-purchase to find out if they wish to designate some portion of a gift card purchase with an organization, the gift card having funds and a merchant associated therewith;
receiving an indication from the user that they do wish to designate some portion of a gift card purchase with an organization;
presenting to the user a choice of donation options;
receiving a donation-type decision from the user;
receiving from the user an organization selection decision;
storing a record of the user decisions; and
deducting a first portion of the funds from the gift-card and transferring the first portion of the funds to an organization selected in the organization selection decision according to the donation-type decision.

2. The method of claim 1 wherein the organization is a charity.

3. The method of claim 1 further comprising sending a receipt to the purchaser for tax deduction purposes when the deducted funds are sent to tax exempt charities.

4. The method of claim 1 further comprising tracking transfers to charities and reporting the transfers to the merchant when a terms of service agreement associated with the gift card provide that the tax deduction accrues to the retailer.

5. The method of claim 1 further comprising tracking the transfers, and then sending data regarding the amount and number of transfers associated with the merchant to the merchant.

6. The method of claim 1 further comprising tracking the transfers, and then sending data regarding the amount and number of transfers associated with the retailer to the retailer.

7. The method of claim 1 further comprising receiving a request from an organization to participate in a organizational fundraising program and automatically verifying that the organization qualifies.

8. The method of claim 1 further comprising providing the user a tracking number so that the user may track the money transferred to a charity.

9. The method of claim 1 wherein the donation-type provides for an immediate portion of the purchase price to immediately be transferred to the organization.

10. The method of claim 1 wherein the donation-type provides for a monthly transfer of a predetermined amount of money from the gift card to the organization.

11. The method of claim 1 wherein the donation-type provides for a transfer of the balance of the gift card to the organization following the expiration of a certain number of months.

12. The method of claim 1 wherein the transfer is an electronic funds transfer.

13. The method of claim 1 further comprising transferring funds to an aggregating account associated with the organization prior to transferring the funds to the organization.

14. The method of claim 13 further comprising receiving from the organization an indication of how the organization wishes to receive funds from the aggregating account.

15. The method of claim 1 further comprising designating a default organization that is designated as the organization to receive funds in the event that the user does not actively select another organization selection.

16. A method of providing organizational fundraising, comprising:
querying a user at a retailer point-of-purchase to find out if they wish to designate some portion of a gift card purchase with an organization, the gift card having funds and a merchant associated therewith;
providing the user with a gift card, the gift card having a unique identification number;
receiving an indication from the user that they do wish to designate some portion of a gift card purchase with an organization;
remotely from the point-of-purchase, identifying the gift card via the identification number, and
presenting to the user a choice of donation options;
receiving a donation-type decision from the user;
receiving from the user an organization selection decision;
storing a record of the user decisions; and
deducting a first portion of the funds from the gift-card and transferring the first portion of the funds to an organization selected in the organization selection decision according to the donation-type decision.

17. The method of claim 16 wherein the remote identification takes place over the Internet.

18. The method of claim 16 wherein the remote identification takes place on a phone.

19. The method of claim 16 wherein the remote identification takes place on a mobile device.

20. The method of claim 16 wherein the act of receiving an indication is received when the user is remote from the point-of-purchase.
